(19) United States
(12) Patent Application Publication
(10) Pub. No.: US 2025/0129252 A1
(43) Pub. Date: Apr. 24, 2025

(54) METHOD FOR INHIBITING CORROSION USING AQUEOUS DISPERSION OF ALKYL BIS AMIDE

(71) Applicant: CHEMTREAT, INC., Glen Allen, VA (US)

(72) Inventors: Dale P. STUART, Glen Allen, VA (US); Robert JEFFERS, Glen Allen, VA (US); Robert BEDINGER, Glen Allen, VA (US)

(73) Assignee: CHEMTREAT, INC., Glen Allen, VA (US)

(21) Appl. No.: 18/381,397

(22) Filed: Oct. 18, 2023

(51) Int. Cl. C09D 5/08

(52) U.S. Cl. CPC C09D 5/086

(57) ABSTRACT

A method of inhibiting corrosion of at least one metal surface that contacts water and/or steam in a water system. The method includes treating the water with a corrosion inhibitor composition including an aqueous dispersion of alkyl bis amide so that the alkyl bis amide forms a protective film on at least a portion of the metal surface.

### BACKGROUND

Corrosion and scaling of metal surfaces in industrial water systems, including boilers, steam generators, closed-loop systems, and cooling systems, is a significant problem across many industries. Corrosion can cause undesirable consequences, such as loss of heat transfer due to, for example, scale deposit on the pipes that acts as an insulator, equipment repairs and replacements, shutdowns, reduced system lifespan, and increased resources and costs.

As an example, boiler systems heat water to produce steam to perform a variety of functions across many different applications, such as power generation, heating, and manufacturing, among others. In a power plant, for example, boilers take in energy from some form of fuel, such as coal, natural gas, or nuclear fuel, to heat water into steam. The pressurized steam can then be used to drive a steam turbine, which may be connected to an electrical generator. After the steam turbine has expanded and partially condensed the steam, the remaining vapor is condensed in a condenser. The liquid water (condensate) produced in the condenser can then be returned to the boiler. Many boiler and feedwater systems are constructed of carbon steel, which requires an elevated pH to inhibit corrosion. Such systems can also include feedwater heaters, condensate systems, and turbines made of stainless steel, aluminum, copper, titanium or alloys thereof. Corrosion of the metal surfaces of boiler systems can be caused by dissolved gasses, such as oxygen and carbon dioxide, acidic environments, and dissolved solids, among others.

Film-forming amines (“FFA”) have been used to inhibit corrosion in boiler and other water systems. FFAs form a protective film on metallic surfaces in boiler and cooling systems that acts as a hydrophobic barrier between the water and the metal surface to prevent corrosion. FFAs are volatile and can distribute with the steam in a boiler so that film formation can also occur on the surfaces of the steam and condensate system to protect those surfaces against corrosion.

However, under boiler conditions, such as extended exposure to high temperatures, FFAs break down into degradation products including, for example, acetic acid, which can break down further into formate and carbon dioxide, and ammonia. These degradation products can lower the pHI of the condensed steam and increase the potential for corrosion. Furthermore, FFA degradation products contribute to cation conductivity, which is a significant concern in practical applications. Cation conductivity represents the sum of the conductivities of all the anions that remain in the solution, with a small contribution from hydrogen ions, after passing through a cation exchange resin. Many power plants routinely measure cation conductivity to detect the presence of corrosive species, such as Cl⁻ and SO₄²⁻, which result from condenser leakage. However, the presence of FFA degradation products, including carbon dioxide, formate, and acetic acid, also contribute to cation conductivity, which can mask the impact of the more corrosive species, making it a less effective tool for detecting the potentially more damaging chloride and sulfate contaminants.

Furthermore, because FFAs are sparingly soluble, they form micelles or “gunk balls” at higher concentrations. These “gunk balls,” which can be difficult clean, can clog pipes, restrict flow, and reduce efficiency.

There is a need in the art for a non-amine film forming product (“FFP”) that can provide robust corrosion protection without breaking down and contributing to cation conductivity or forming “gunk balls.”

### SUMMARY

Disclosed herein is a method of inhibiting corrosion of at least one metal surface that contacts water and/or steam in a water system that overcomes the disadvantages of the prior art techniques. The method includes treating the water with a corrosion inhibitor composition including an aqueous dispersion of alkyl bis amide so that the alkyl bis amide forms a protective film on at least a portion of the metal surface.

### BRIEF DESCRIPTION OF THE DRAWINGS

FIG. 1A is a photograph of liquid phase test coupons in a boiler treated with a commercial corrosion inhibitor composition (commercial benchmark).

FIG. 1B is a photograph of liquid phase test coupons in a boiler treated with an aqueous dispersion of alkyl bis amide as a corrosion inhibitor FFP.

FIG. 2A is a photograph of vapor phase test coupons in a boiler treated with the commercial corrosion inhibitor composition.

FIG. 2B is a photograph of vapor phase test coupons in a boiler treated with the alky bis amide-based FFP.

FIG. 3 is a line chart showing the corrosion rates of the commercial benchmark composition and the alky bis amide-based FFP in the liquid and vapor phases of a boiler.

### DETAILED DESCRIPTION OF EMBODIMENTS

In the following description, numerous details are set forth to provide an understanding of the present disclosure. However, it may be understood by those skilled in the art that the compositions and methods of the present disclosure may be practiced without these details and that numerous variations or modifications from the described embodiments may be possible.

The present disclosure provides a composition including an aqueous dispersion of alkyl bis amide that can be used as a non-amine film-forming corrosion inhibitor in water systems, such as boilers, steam generators, closed-loop systems, and cooling systems. When the aqueous dispersion is introduced into a water system, the alkyl bis amide can form a monomolecular hydrophobic film or layer on metal surfaces that contact water and/or steam. The protective film can act as a barrier against corrosion due to its water-repellant behavior. For instance, the alkyl bis amide film can protect the metal surface against corrosive agents, such as oxygen, carbon dioxide, and carbonic acid. Alkyl bis amide is also volatile. Therefore, when the dispersion is introduced into a boiler system, for example, the alkyl bis amide molecules can distribute in both the liquid and vapor phases of the boiler system. This allows the alkyl bis amide to distribute with the steam and to be transferred through the condensate system. As such, the alkyl bis amide can form a protective film on metal surfaces that contact liquid water and/or steam in not only the boiler (steam generator), but also the condensate system. Alkyl bis amide can provide corrosion protection in the whole steam-water cycle of powers plants, as well as auxiliary systems and other industrial water systems. In addition to corrosion protection, alkyl bis amide keeps heat transfer surfaces free from scale and deposits, which can optimize heat transfer rates and reduce fuel usage.

The alky bis amide-based corrosion inhibitor composition disclosed herein not only provides robust corrosion protection, but offers many advantages over the currently-used FFAs. For instance, alkyl bis amides are more temperature stable than FFAs and there is less breakdown of alkyl bis amides into degradation products that can increase cation conductivity. As such, alkyl bis amides do not contribute significantly to the cation conductivity of a water system, such as a boiler system. For example, the alkyl bis amide may contribute to an increase in cation conductivity of the boiler system by less than 0.2μmho, less than 0.1 μmho, or less than 0.05 μmho. Additionally, unlike FFAs, alkyl bis amides can be introduced into the water system without adverse effects, such as forming gunk balls or micelles that clog pipes, restrict flow, and reduce efficiency.

### Corrosion Inhibitor Composition

In the disclosed corrosion inhibitor composition, the alkyl bis amide may be a long chain alkyl bis amide including at least two branched or unbranched, substituted or unsubstituted, saturated aliphatic groups having 5 to 40 carbon atoms, 10 to 24 carbon atoms, or 14 to 20 carbon atoms. In one embodiment, the long chain alkyl bis amide includes at least two unsubstituted alkyl groups, and in another embodiment the at least two unsubstituted alkyl groups are unbranched. The alkyl bis amide may have a chemical structure represented by the following formula (I):

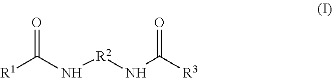

In formula (I), R¹ and R³ may independently be a branched or unbranched alkyl group having 5 to 40 carbon atoms, 10 to 26 carbon atoms, or 14 to 22 carbon atoms, and R² may be a branched or unbranched alkyl group having 1 to 22 carbon atoms, 2 to 10 carbon atoms, or 2 to 6 carbon atoms. R¹ and R³ may be the same or different. A suitable alkyl bis amide may include, for example, ethylene bis-stearamide (EBS).

In the alkyl bis amide, the free electron pair of each amide nitrogen has a strong affinity for metals so that the alkyl bis amide bonds to metal surfaces of the water system with the hydrocarbon tails (R¹ groups) on each end of the amides extending outwardly to impart strong water repellence to the metal surface. The alkyl bis amide can bond to metals, such as carbon steels or mild steel that are often used in boilers and condensate systems. The alky bis amide can also bond to various other metal surfaces, including, for example, surfaces made of aluminum, copper, titanium or alloys thereof, which can also be used in heat exchange surfaces and/or turbines. The alkyl bis amide forms an invisible monomolecular layer on the metal surface of the water system that imparts hydrophobicity to the metal surface. The hydrophobicity makes steam condense in droplets and protects the metal surface against corrosion, which can boost heat transfer rates.

Without wishing to be bound by theory, it is believed that the alkyl bis amide bonds to the metal surface differently than the currently-used FFAs, and lays down differently on the metal surface. Although the free electron pair of the amine nitrogen in FFAs also bonds with the metal surface, it is believed to form a covalent sigma bond, whereas the amide nitrogens in alkyl bis amide form an electrostatic bond with the metal surface of the boiler. Unlike the sigma bond formed by FFAs, the bond length of the electrostatic bond formed by the alkyl bis amide does not increase with temperature. Additionally, alkyl bis amide, which includes two long chain alkyl groups, lays down on the metal surface differently than the FFAs. Currently-used FFAs include amines, such as octadecyl amine and oleyleamine, and diamines, such as N-olyelpropane-1,3-diamine. However, both the amines and diamines only include an alkyl group on one end. The single alkyl group in FFAs projects away from the metal surface. On the other hand, the alkyl groups (R¹ groups in formula (I)) on the ends of the alkyl bis amide extend more parallel to the metal surface when the amide nitrogens bond with the metal surface.

The alkyl bis amide is formulated into a stable micronized aqueous dispersion. The aqueous dispersion includes dispersed solid particles that include the alkyl bis amide. The solid particles are micronized particles including the alkyl bis amide that are dispersed in the water. It may be preferable to produce an aqueous dispersion as compared to an emulsion (e.g., in which fine droplets of one liquid are dispersed in another liquid, such as water). Emulsions are not as effective and often use silica, chlorides, and phosphates that are corrosive in water systems, such as boilers. In the present dispersion, solid microparticles of the alkyl bis amide may be evenly or uniformly dispersed in water.

It can be difficult to disperse alkyl bis amide in water due to its hydrophobic nature, and the resulting dispersions can have a relatively short life and poor stability due to the tendency of the alkyl bis amide to settle out of suspension. These problems can be overcome and a stable aqueous dispersion can be formed by minimizing the particle size of the alkyl bis amide, which may be in the form of solid waxy particles dispersed in water. The particle size can be important for both performance and stability of the dispersion. In this regard, as the particle size increases, instability of the dispersion increases, and performance may decrease. For example, to enhance dispersibility and form a stable dispersion, the solid particles including the alkyl bis amide may have an average particle size in a range of 0.1 μm to 20 μm, 0.2 to 10 μm, or 0.5 to 2 μm. The resulting micronized aqueous dispersion can be stable and have an increased shelf life. For example, the aqueous dispersion may be stable for greater than 30 days, greater than 60 days, greater than 6 months, or greater than 1 year.

The aqueous dispersion may also include a surfactant to further enhance dispersibility of the alkyl bis amide and stability of the dispersion. The surfactant may include, for example, ethoxylated fatty acids, such as polyethylene glycol monostearate, ethoxylated tallow amines, ethoxylated alcohols, a fatty acid amide, such as a C₆ to C₂₈ fatty acid amide, or a salt thereof, or any other surfactant suitable for use in water systems. The ethoxylated fatty acids may have a degree of ethyoxylation in a range of from 5 to 40, 10 to 30, or 15 to 25. A weight ratio of the surfactant to the alkyl bis amide may be in a range of 1:3 to 4:1, 1:2 to 3:1, or 1:1 to 2:1.

The aqueous dispersion may be produced by any suitable method. For example, micropowders of the alkyl bis amide having a similar size distribution may be added to a hot water solution including, for example, one or more surfactant. Alternatively, alkyl bis amide powder can be melted and dispersed in water through high shear mixing to produce the micronized dispersion.

### Methods of Inhibiting Corrosion

The stable micronized aqueous dispersion of alkyl bis amide can be used in a method of inhibiting corrosion of a metal surface that contacts an aqueous fluid, such as water and/or steam, in a water system. The alkyl bis amide dispersion may be introduced into open or closed water systems, and can be applied to the water stream while the water system is on-line. The methods of inhibiting corrosion can be used in water systems including, but not limited to boilers, condensate systems, cooling water, cooling towers, heat exchangers, and the like. In general, the aqueous fluid (e.g., water and/or steam/water vapor) in these water systems is at least 90 wt. % water, at least 95 wt. % water, or at least 99 wt. % water.

The method includes treating the aqueous fluid with a corrosion inhibitor composition including an aqueous dispersion of alkyl bis amide so that the alkyl bis amide forms a protective film on at least a portion of the metal surface that contacts the aqueous fluid. The corrosion inhibitor composition may be introduced into a feedwater of the water system, such as by mechanically feeding the corrosion inhibitor composition into the feedwater system. The corrosion inhibitor composition may be continuously or periodically supplied into the water system to provide continuous corrosion protection. The corrosion inhibitor composition may be supplied to the water system so that the water in the water system is treated with an effective concentration of the alkyl bis amide for inhibiting corrosion. In particular, the corrosion inhibitor composition may be added to the water system so that enough of the alkyl bis amide is present in the system to develop the film on at least a portion of the metal surface that contacts water and/or steam. For example, the corrosion inhibitor composition may be supplied to the boiler or other water system so that a concentration of the alkyl bis amide in the water in the boiler or other water system is in a range of 0.01 to 10 ppm, 0.05 to 8 ppm, 0.1 to 5 ppm, or 0.2 to 3 ppm.

The water system may be any system in which water is heated and/or cooled. For example, the water system may be a boiler system, in which case the alkyl bis amide can form a protective film on at least a portion of a metal surface in contact with the water and/or steam in the boiler system. The boiler system, which may be any suitable system for generating steam, can include a feedwater system, at least one boiler, and a condensate system. In operation, the feedwater system provides feedwater for the at least one boiler, the at least one boiler heats the feedwater to produce steam, which can then be used to drive a steam turbine or perform other work, and the condensate system includes a condenser that condenses the steam exhaust from the turbine to produce condensate. The liquid condensate may be then recycled for used in the at least one boiler. As such, the condensate system may also include piping for delivering the condensate to be used in the at least one boiler.

In one embodiment, the corrosion inhibitor composition may be introduced, for example, mechanically fed, into the feedwater of the boiler system, such as in a feedwater supply or feedwater line at a position upstream of the at least one boiler. Alternatively or additionally, the corrosion inhibitor may be introduced into the boiler water in the boiler. The corrosion inhibitor composition may be continuously or periodically supplied into the boiler system. As discussed above, the corrosion inhibitor composition may be supplied to the boiler system so that the water in the boiler system is treated with an effective concentration of the alkyl bis amide to develop the film for inhibiting corrosion. For example, the corrosion inhibitor composition may be supplied to the boiler system so that a concentration of the alkyl bis amide in the boiler water is in a range of 0.05 to 20 ppm, 0.1 to 10 ppm, 0.15 to 5 ppm, or 0.2 to 1 ppm.

Because alkyl bis amide is less likely to break down into degradation products that contribute to cation conductivity or produce “gunk balls” when introduced at higher concentrations, the amount of the alkyl bis amide that is introduced into the water system is less restricted than the currently used FFA-based corrosion inhibitor compositions. The alky bis amide-based corrosion inhibitor composition can thus be fed at higher concentrations without adverse effects. Without wishing to be bound by theory, it is believed that the alkyl bis amide will build up concentration in the system to provide continued protection. Once the protective film is formed, it can remain intact even after feeding of the aqueous dispersion of alkyl bis amide has stopped. If the dosage falls below the required level or is interrupted for a short period, then no immediate corrosion occurs, making it resilient to system upsets.

The water in the water system may have a higher temperature than the melting point of the solid particles of the aqueous dispersion. Therefore, adding the aqueous dispersion to the water may cause the solid particles in the aqueous dispersion to melt in the water. For instance, when the aqueous dispersion is introduced into a boiler system, the solid particles including the alkyl bis amide may melt in the water in the at least one boiler. The temperature of the water in the water system may be at least 70° C., at least 150° C., or least 200° C. The alkyl bis amide particles may be transferred from the solid state to the liquid state, and may distribute in the water (liquid phase) in the at least one boiler to form a protective film on at least a portion of the metal surface of the boiler that contacts the water. The alkyl bis amide is volatile, and therefore, treating the water with the aqueous dispersion may cause the alkyl bis amide to distribute in water vapor that is present in the water system. For example, due to its volatility, some of the alkyl bis amide molecules may be transferred from the liquid state to the vapor state to distribute in the steam in the at least one boiler and may be delivered through the condensate system with the steam. Therefore, the alkyl bis amide can form a protective film not only on at least a portion of a metal surface of the at least one boiler that contacts water and/or steam, but also on at least a portion of a metal surface of the condensate system, including condensate return lines, that contacts water (e.g., condensate) and/or steam. The alky bis amide dispersion can thus provide whole system protection from corrosion by forming a protective film on the metal surfaces of the whole boiler and condensate system that contact boiler water, steam, and/or condensate.

The aqueous dispersion of alkyl bis amide can be introduced into the boiler or other water system by itself or it may be blended with other corrosion inhibitors, such as neutralizing amines. Neutralizing amines are often added to water systems to increase the pH for inhibiting corrosion. In particular, a higher pH prevents the formation of carbonic acid from carbon dioxide in air, which itself can attack equipment. Typical neutralizing amines are lower molecular weight amines such as morpholine, cyclohexylamine, diethylethanol amine, and methoxypropyl amine. The neutralizing amines can be present in the water in amounts of, for example, from 0.5 to 50 ppm, from 1 to 30 ppm, from 5 to 25 ppm, and from 10 to 20 ppm.

The boiler system may be, for example, a heat recovery steam generator system. Such a system may be used in a power plant, for example, a gas turbine combined cycle power plant. A heat recovery steam generator can recover waste heat from a hot gas stream, such as a combustion turbine or other waste stream, and use the recovered heat to produce additional steam that can be used to drive a steam turbine, for example. The heat recovery steam generator system may include one or more of a low pressure (LP) boiler, an intermediate pressure (IP) boiler, and a high pressure (HP) boiler. Feedwater may flow through the LP, IP, and HP boilers to generate steam at multiple pressure levels. For instance, steam pressure in the HP boiler may be higher than in the IP boiler, and steam pressure in the IP boiler may be higher than in the LP boiler. A triple pressure system, including an LP, IP, and HP boiler, can maximize thermal efficiency. The aqueous dispersion of alkyl bis amide may be introduced into the feedwater so as to be distributed in one or more of the LP, IP, and HP boilers so that the alky bis amide forms a protective film on at least a portion of the metal surface of one or more of the LP, IP, and HP boilers. For example, the alkyl bis amide can form a protective film on at least a portion of the metal surface in the liquid and/or vapor phases of each boiler. Advantageously, the alkyl bis amide can inhibit corrosion in the liquid and vapor phases of a HP boiler, which may have pressures up to or beyond 2400 psig and temperatures up to 350° C. or higher.

Although the above disclosure describes the use of the aqueous dispersion of alkyl bis amide to inhibit corrosion in boiler systems, the present disclosure is not limited to this. The aqueous dispersion of alkyl bis amide may be used to inhibit corrosion in any suitable system, including other water systems, such as cooling towers, closed loop systems, and heat exchangers. For example, the water system may be a closed system that includes water and water vapor. As discussed above with respect to boiler systems, the closed system may include at least one metal surface that contacts water and/or water vapor. The at least one metal surface may include a first surface that is in contact with the water and a second surface that is in contact with the water vapor. When the water in the closed system is treated with the aqueous dispersion of the alkyl bis amide, the alkyl bis amide may be distribute in the liquid and vapor phases of the closed system. As such, a protective film may be formed on at least a portion of the first surface and the second surface. Thus, the aqueous dispersion of the alkyl bis amide may provide corrosion protection to the entire closed system.

The foregoing is further illustrated by reference to the following examples, which are presented for purposes of illustration and are not intended to limit the scope of the present disclosure.

### EXAMPLES

In the following examples, a research boiler was developed to simulate high pressure power applications. The research boiler included a flow through system with multiple chemical injection ports, a feed system including reverse osmosis (RO) water with deaeration capability and auto filling, a boiler system including LP, IP, and HP boiler drums, as well as steam and drum sampling capabilities during operation. The HP boiler had a pressure range up to 2400 psig and temperature up to 350° C.

A stable micronized aqueous dispersion of ethylene bis stearamide (average particle size=3 to 5 μm) was produced. 100 ml reverse osmosis (ro) water was heated to 50° C. used to dissolve 5-15 g of ethoxylated fatty acid. 2-15 g of ethylene bis stearamide micropowder was added to solution under high shear mixing. The solution was mixed until a stable dispersion was obtained.

Mild steel test coupons were arranged in the vapor and liquid spaces of the boiler. The pH of the boiler water was adjusted to 10.0 with ammonium hydroxide, and the aqueous dispersion of ethylene bis stearamide was introduced into the feedwater system of the research boiler at a concentration of 20 ppm. The concentration was cycled up to artificially increase concentration to film the vessel and test coupons. A static 24 hour research boiler test was conducted in which the pressure and temperature of the HP boiler was 2400 psig and 350° C., respectively.

As a comparative example, a commercial non-amine filming product was introduced into the feedwater system at a concentration of 20 ppm, and a static 24 hour research boiler test was conducted under the same conditions.

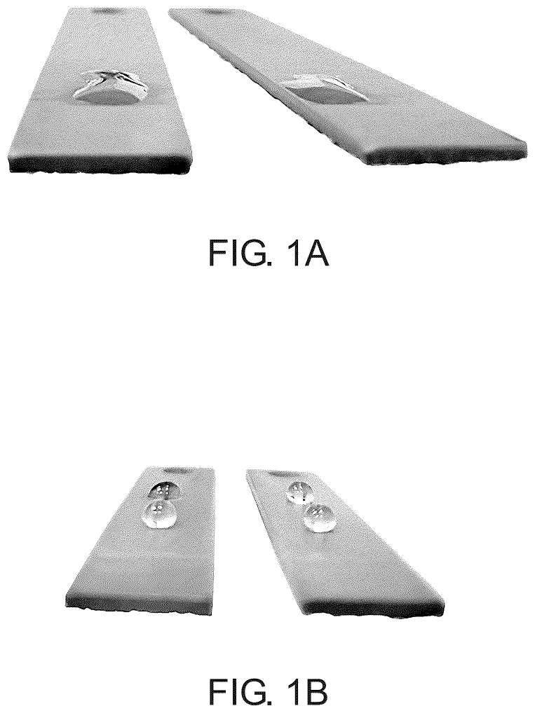

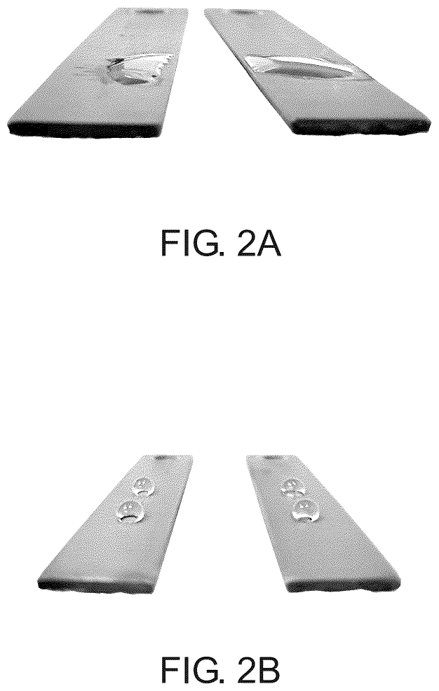

Hydrophobicity of the test coupons after treating with the ethylene bis stearamide composition and the commercial non-amine composition, respectively, was evaluated by a 25 ml water drop test. The results are shown in FIGS. 1A-2B. FIGS. 1A and 1B show the liquid phase test coupons from the boiler after treating with the commercial non-amine composition and the ethylene bis stearamide composition, respectively. The water droplet on the liquid phase test coupon in FIG. 1B is round, showing a high water contact angle, whereas the water droplet on the liquid phase test coupon in FIG. 1A is flat, having a low water contact angle. This demonstrates that the liquid phase test coupon after treatment with the ethylene bis stearamide composition (FIG. 1B) is significantly more hydrophobic than the liquid phase test coupon after treatment with the commercial non-amine composition (FIG. 1A). Similar results were obtained with the vapor phase test coupons after treatment with the commercial non-amine composition (FIG. 2A), and the ethylene bis stearamide composition (FIG. 2B), respectively. Indeed, the water droplet on the vapor phase test coupon after treatment with the commercial non-amine composition is flat (FIG. 2A), whereas the water droplet on the vapor phase test coupon after treatment with the ethylene bis stearamide composition is round (FIG. 2B), showing that the surface of the vapor phase test coupon was more hydrophobic after treatment with the ethylene bis stearamide composition than after treatment with the commercial non-amine composition.

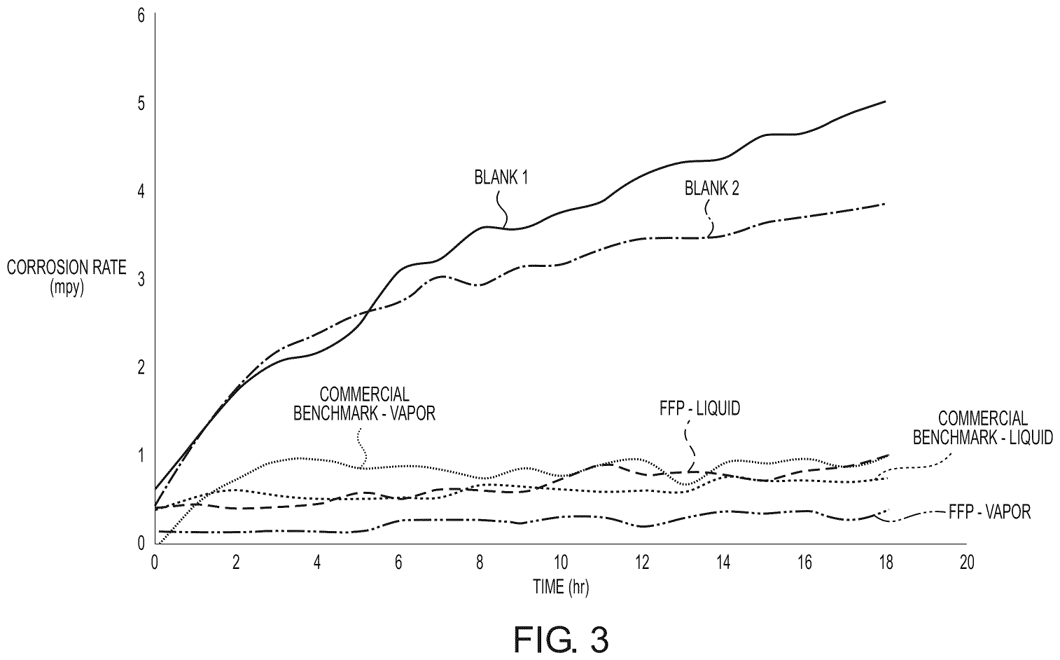

Linear Polarization Resistance (LPR) E-chem testing (200 ppm NaCl, pH=10.0, room temperature, 18 hours) was performed to evaluate corrosion rates of the test coupons. FIG. 3 shows the results of the LPR E-chem tests. FIG. 3 shows that the ethylene bis stearamide composition (FFP) exhibited better corrosion inhibition than the commercial non-amine composition (commercial benchmark) in the vapor phase of the boiler and approximately the same corrosion inhibition in the liquid phase of the boiler as compared to the commercial non-amine composition. The results show that the alkyl bis amide-based FFP can provide corrosion protection that is comparable to or better than the commercial benchmark product.

Although some embodiments of the invention have been described in detail above, those skilled in the art will readily appreciate that many modifications are possible in the example embodiments without materially departing from the disclosed embodiments. Accordingly, all such modifications are intended to be included within the scope of this disclosure as defined in the following claims.

What is claimed is:

1. A method of inhibiting corrosion of at least one metal surface that contacts water and/or steam in a water system, the method comprising:
treating the water with a corrosion inhibitor composition including an aqueous dispersion of alkyl bis amide, wherein the alkyl bis amide forms a protective film on at least a portion of the metal surface.

2. The method according to claim 1, wherein the aqueous dispersion comprises dispersed solid particles that include the alkyl bis amide.

3. The method according to claim 2, wherein an average particle size of the dispersed solid particles in the aqueous dispersion is in a range of 0.1 μm to 20 μm.

4. The method according to claim 2, wherein an average particle size of the dispersed solid particles in the aqueous dispersion is in a range of 0.5 μm to 2 μm.

5. The method according to claim 2, wherein the water has a higher temperature than the melting point of the solid particles.

6. The method according to claim 5, wherein the treating step includes adding the aqueous dispersion to the water to cause the solid particles to melt in the water.

7. The method according to claim 5, wherein the temperature of the water is at least 70° C.

8. The method according to claim 1, wherein the alkyl bis amide is volatile and the treating step includes adding the aqueous dispersion to the water to cause the alkyl bis amide to distribute in water vapor that is present in the water system.

9. The method according to claim 1, wherein the alkyl bis amide includes at least two long chain alkyl groups independently including 5 to 40 carbon atoms.

10. The method according to claim 1, wherein the alkyl bis amide has a chemical structure represented by formula (I): 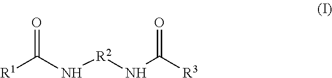
where:
R¹ and R³ are independently a branched or unbranched alkyl group having 5 to 40 carbon atoms; and
R² is a branched or unbranched alkyl group having 2 to 22 carbon atoms.

11. The method according to claim 10, wherein:
R¹ and R³ are independently a branched or unbranched alkyl group having 10 to 24 carbon atoms; and
R² is a branched or unbranched alkyl group having 2 to 6 carbon atoms.

12. The method according to claim 1, wherein the protective film is a monomolecular layer that imparts hydrophobicity to the metal surface.

13. The method according to claim 1, wherein the aqueous dispersion further comprises a surfactant.

14. The method according to claim 13, wherein a weight ratio of the surfactant to the alkyl bis amide in the aqueous dispersion is in a range of 1:2 to 3:1.

15. The method according to claim 1, wherein a concentration of the alkyl bis amide in the water in the water system is in a range of 0.05 to 20 ppm.

16. The method according to claim 1, wherein (i) the water system is a closed system that includes water and water vapor, and (ii) the at least one metal surface includes a first surface that is in contact with the water and a second surface that is in contact with the water vapor; wherein the protective film is formed in the first surface and the second surface.

17. The method according to claim 1, wherein the water system is a boiler system that includes at least one boiler that generates steam and a condensate system where the steam condenses as a condensate.

18. The method according to claim 17, wherein the corrosion inhibitor composition is introduced into a feedwater system of the boiler system.

19. The method according to claim 17, wherein the alkyl bis amide distributes in the liquid phase and the vapor phase of the boiler system so that the protective film is formed on: (i) at least a portion of the metal surface of the at least one boiler that contacts water and/or steam, and (ii) at least a portion of a metal surface of the condensate system that contacts water and/or steam.

20. The method according to claim 17, wherein the boiler system is a heat recovery steam generator including a low pressure boiler and a high pressure boiler, and the alkyl bis amide forms a protective film on at least a portion of a metal surface of each of the low pressure boiler and the high pressure boiler.
